(19) United States
(12) Patent Application Publication
(10) Pub. No.: US 2011/0184534 A1
(43) Pub. Date: Jul. 28, 2011

(54) CONFIGURATION OF ORDERED MULTICOMPONENT DEVICES

(75) Inventors: GARABED YERIAZARIAN, HOUSTON, TX (US); MOHAMMAD REHAN SIDDIQUI, SPRING, TX (US); EN PENG, HOUSTON, TX (US)

(73) Assignee: BAKER HUGHES INCORPORATED, Houston, TX (US)

(21) Appl. No.: 12/694,669

(22) Filed: Jan. 27, 2010

(51) Int. Cl. G06F 15/16; G05B 15/02

(52) U.S. Cl. 700/9; 709/227

(57) ABSTRACT

A method of configuring communications between a computing device includes coupling the one or more SIE units to a communication link; receiving at the computing device an indication that the one or more SIE units are coupled to the communication link; selecting one or more of the one or more SIE units for connection; and transmitting an internet protocol address to the selected SIE units.

### BACKGROUND

This invention relates generally to control devices and, more particularly, to the identification and control of particular components that form a multi-component device.

In the drilling and completion arts it may be desirable to control or monitor some or all of the devices placed in a downhole environment. One example of devices that may need to be controlled or monitored are valves and sensors.

To accommodate this interest, lines such as fiber optic lines, electric lines, hydraulic lines, etc are installed adjacent and coupled the devices the string. The lines may be installed in a number of positions relative to, for example, a completion string such as at the inside dimension of the string, somewhere within various concentric layers of the string or outside of the string, for example, on a surface thereof or spaced therefrom. These lines may allow for communication and control of the devices forming part of the completion string. Of course, other devices may also be of interest.

### SUMMARY

In one aspect, a method of configuring communications between a computing device and one or more surface interface electronic (SIE) units is disclosed. The method of this aspect includes coupling the one or more SIE units to a communication link; receiving at the computing device an indication that the one or more SIE units are coupled to the communication link; selecting one or more of the one or more SIE units for connection; and transmitting an internet protocol address to the selected SIE units.

In another aspect, a method of configuring the operation of a multi-component device having a plurality of devices is disclosed. This aspect includes receiving at a computing device over the control line a hardware address for each of the plurality of devices; forming an ordered list of the plurality of devices; performing a test of the multi-component device; and changing an order of the of the ordered list based on observations of the test.

### BRIEF DESCRIPTION OF THE DRAWINGS

Referring now to the drawings wherein like elements are numbered alike in the several Figures:

FIG. 1 shows an example of a system according to one embodiment;

FIG. 2 is a flow chart showing one method of identifying and assigning addresses to the surface interface electronics (SIEs) shown in FIG. 1;

FIG. 3 shows an example of a multi-component device according to one embodiment; and

FIG. 4 is a flow chart showing a method of configuring the nodes of a multi-component device according to one embodiment.

### DETAILED DESCRIPTION

Embodiments disclosed herein are directed to systems and methods for identifying and communicating with one or more completion strings. In addition, systems and methods are disclosed for identifying and communicating with individual devices on a completion string. In one embodiment, the completion string may be referred to as a multi-component device and includes multiple, separate devices. In one embodiment, each device is an active flow control device (AFCD). In one embodiment, the AFCD includes a valve.

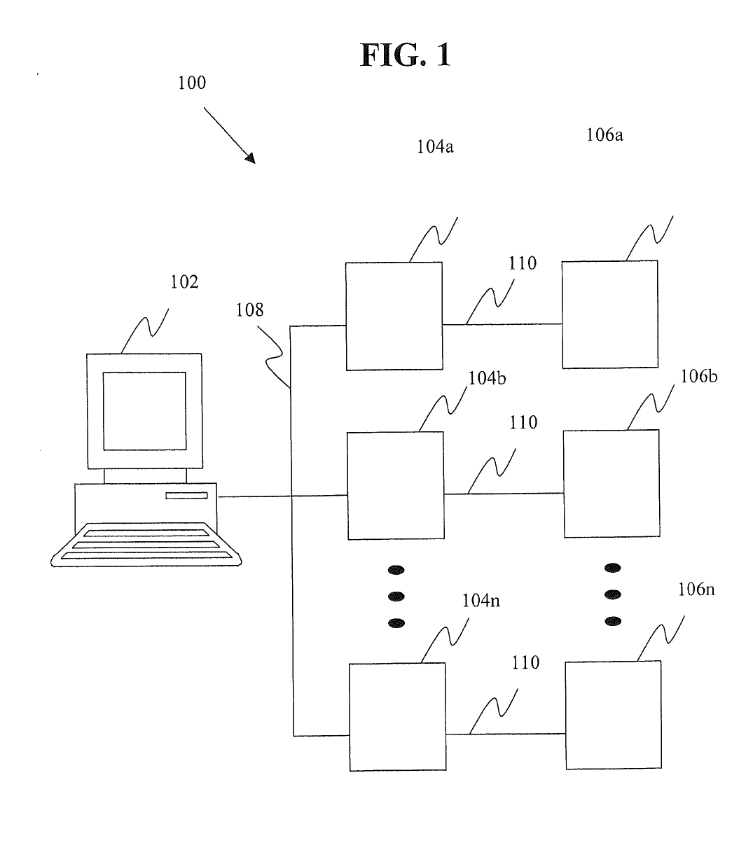

FIG. 1 shows an example of a system 100 according to one embodiment. The system 100 includes a central computing device 102. The central computing device 102 may be a site-specific computing device in some embodiments. That is, the computing device 102 may be located at a particular operating location. For example, the computing device 100 may be at an in ground-based product production location. Of course, the teachings herein could be applied in other contexts as well.

The computing device 102 may be coupled, in one embodiment, to a supervisory control and data acquisition (SCADA) system (not shown). It shall be understood that the computing device 102 may include memory for storage of instructions and information, and input device(s) for computer communication. For example, the computing device 102 may include devices allowing for communicate with a SCADA system (not shown) or other devices, such as the surface interface electronics (SIEs) 104.

Due to the capabilities of the computing device 102 (or other devices in the system 100 either shown or not shown), the present invention may be implemented, in software, for example, as any suitable computer program on a computer system somewhat similar to computer system 102. For example, a program in accordance with the present invention may be a computer program product causing a computer to execute the example methods described herein. The computer program product may include a computer-readable medium having computer program logic or code portions embodied thereon for enabling a processor of a computer system (e.g., 102) to perform one or more functions in accordance with one or more of the example methodologies described above. The computer program logic may thus cause the processor to perform one or more of the example methodologies, or one or more functions of a given methodology described herein.

The computer-readable storage medium may be a built-in medium installed inside a computer main body or removable medium arranged so that it can be separated from the computer main body. Examples of the built-in medium include, but are not limited to, rewriteable non-volatile memories, such as RAMs, ROMs, flash memories, and hard disks. Examples of a removable medium may include, but are not limited to, optical storage media such as CD-ROMs and DVDs; magneto-optical storage media such as MOs; magnetism storage media such as floppy disks (trademark), cassette tapes, and removable hard disks; media with a built-in rewriteable non-volatile memory such as memory cards; and media with a built-in ROM, such as ROM cassettes.

The system 100 may also include one or more surface electronic interfaces (SIEs) 104a-104n. The system 100 may also include one or more multi-component devices 106a-106n.

The SIEs 104 serve to allow for communication between the computing device 102 and a multi-component device 106 coupled to a particular SIE 104. In one embodiment, each SIE 104 has a multi-component device 106 coupled thereto. Of course, the system 100 may include SIEs 104 not coupled to a multi-component device. In one embodiment, only one multi-component device 106 may be coupled to a single SIE 104.

Aspects of the present invention may provide for establishing and/or continuing communication between the computing device 102 and the SIEs 104 and between the computing device 102 and some or all of the components of the multi-component devices 106a-106n.

In one embodiment, the SIEs 104 are coupled to the computing device 102 via communication link 108. In one embodiment, the communication link 108 is an Ethernet connection.

The SIEs 104 serve as intermediate nodes between the computing device 102 and each multi-component device 106. In operation, the SIEs 104 may receive commands from the computing device 102, translate them into a form understandable by the multi-component devices 106, and provide the commands to the multi-component devices 106. The SIEs 104 may also provide or control power delivered to the multi-component devices 106. In addition, the SIEs 104 may receive information from the multi-component devices 106, convert it into a form recognizable by the central computing device 102, and provide the information to the central computing device 102. Of course, depending on the circumstance, the SIEs 104 may provide some or all of the functions described above. For example, the SIE may not be required to translate/convert in some instances.

The SIEs 104 are coupled to the multi-component devices 106 via control link 110. In one embodiment, the control link 110 is a tubing encapsulated connector (TEC).

The system 100 shown in FIG. 1 may require a communications protocol for effective operation. On power up (or on a restart) the system 100 may need to identify its components and assign addresses to one or more of the SIEs 104, the multi-component devices 106 and individual devices forming the multi-component devices 106 in order for the computing device 102 to control operation of the system 100. In one embodiment, the SIEs 102 may also be configured with static addresses that are discovered at runtime or specified through a system configuration.

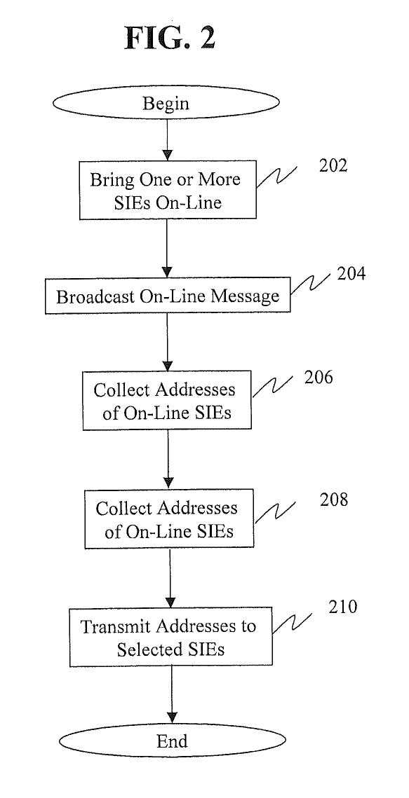

FIG. 2 is flow chart showing one method of identifying and assigning addresses to the SIEs 104 shown in FIG. 1. At a block 202 one or more SIEs are powered up. In one embodiment, each SIE is powered up (or restarted) in a so-called amnesia state. In an amnesia state, the SIE does not know its environment (i.e., the elements it is connected to) and, accordingly, does not know its role.

At a block 204 each SIE broadcasts a message that it is online. In one embodiment, the broadcast may be made, for example, over the communication link 108. The broadcast may include an SIE identifier. This identifier may be unique for each SIE. In one embodiment, the message may be addressed to a global “everyone” address. Such an address ensures that every element coupled to the communication link receives the broadcast. In one embodiment, the broadcast by each SIE may include a “to” field, a message field, and an SIE identifier field. In one embodiment, the “to” field may include an “everyone” indication, the message field may include an indication that the SIE is on-line and the SIE identifier field may include an identification number of the SIE. The broadcast of block 204 may continue periodically until instructed to stop.

At a block 206, the computing device 102 collects all of the addresses of the broadcasting SIEs. It shall be understood that the communication link 108 may be an Ethernet controlled by the computing device 102.

At a block 208 one or more of the SIEs are selected. Selection may include, in one embodiment, providing a list of SIEs to a human user and receiving selections from the user. Of course, in one embodiment, the selection may be automated.

At a block 210, the computing device 102 transmits messages to the attention of each of the selected SIEs assigning a unique address to each selected SIE. After the message has been sent, the SIE has unique address and may then be configured or otherwise manipulated by the computing device 102.

The preceding method may be carried out in many different contexts. For example, in one embodiment, the preceding method may occur between the computing device and a single, newly activated SIE. In such an embodiment, the computing device may already be controlling or otherwise communicating with other SIEs. In another embodiment, multiple SIEs may be simultaneously (or near simultaneously) activated. Such a condition may occur, for example, when a rack containing multiple SIEs has its power cycled or regains power after a power loss.

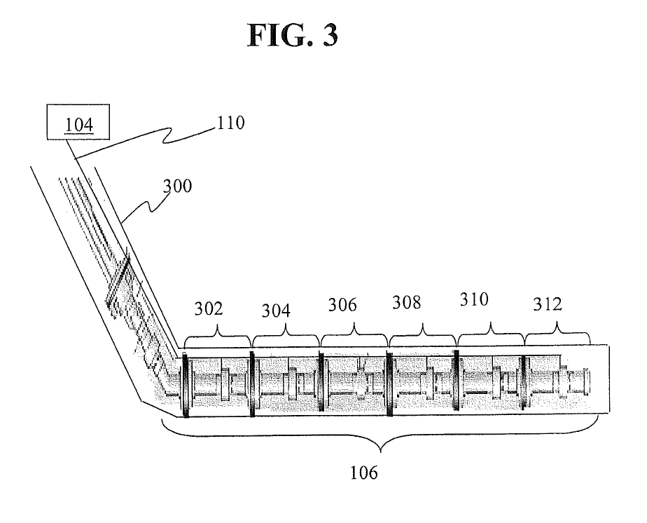

FIG. 3 shows an example of a multi-component device 106 according to one embodiment. In this example, the multi-component device 106 is part of a completion string that may be utilized in the collection of a ground-based product as installed in a production well having walls 300. It shall be understood that the teachings herein may be applied, however, to other contexts as well.

The multi-component device 106 includes, in this example, a plurality of sequentially arranges devices 302, 304, 306, 308, 310 and 312. The number of sequentially arranged devices is variable and the six devices (302, 304, 306, 308, 310 and 312) are shown by way of example only.

Each device may be coupled by a control link 110 to, for example, an SIE 104. As shown, each device is an active flow control device (AFCD). Of course, the devices could be formed of other elements.

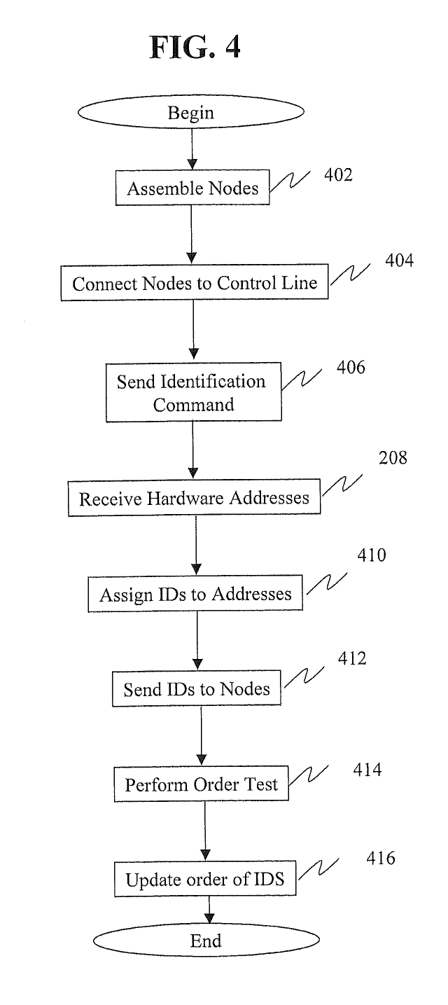

FIG. 4 is a flow chart of a method of configuring communications between one of the multi-component devices 106 and the computing device 102 (FIG. 1). Each device of the multi-component device includes memory for storing a unique address assigned when it is created. In one embodiment, each device is the same type of device. As such, the devices may be sent separately and assembled in a serial manner at a job location. The ordering of the devices may be important for control reasons and this may require that the devices be assembled in a particular order. That is, determining which device goes in which location may require pre-planning. To overcome this shortcoming, the method shown in FIG. 4 may be utilized.

At a block 402 the devices of a multi-component device are assembled. As discussed above, each device may be formed of the same or substantially the same type of element. For instance, the multi-component device may be formed of plurality of serially connected AFCDs for use in extraction of a ground-based product. The assembly may not require any particular ordering of the nodes according to one embodiment.

At a block 404, each device is coupled to a control link. For example, each device may be coupled to a TEC that is connected to an SIE. In one embodiment, the devices are connected to the control link in a daisy-chain configuration.

At a block 406 an initial identification command is sent to each device. The command may be sent to each device simultaneously in one embodiment. The command may be sent by either the SIE, the computing device, or may be automatic when the device is powered up. The command may cause each device to return its unique hardware address.

At a block 408 the hardware addresses received are stored at the computing device. The order of the devices (and hence, the order of the hardware addresses) is irrelevant at this point.

At a block 410 each address is assigned a reference identification number or other identifier. The reference identification number is then sent to the node to which it applies at block 412.

At a block 414 an order test is performed. The order test causes the nodes to perform an action in an order that the computing device believes to be the order the devices are arranged in. For example, the nodes may be instructed to open or close in the order of the hardware addresses are stored in block 408. Of course, this order may not be correct.

At a block 416, the order is updated. This update may require inspection by a human operator to see the order in which the devices opened or closed. With the updated order, the control device (i.e., computing device 102 of FIG. 1) now has an order and identifier for each of the nodes in the multi-component device.

Of course, it shall be understood, that instead of connecting all the devices and checking the ordering, the devices may connected one at a time and assigned sequential addresses (or aliases). This way, the system is able to determine the correct ordering of devices.

While one or more embodiments have been shown and described, modifications and substitutions may be made thereto without departing from the spirit and scope of the invention. Accordingly, it is to be understood that the present invention has been described by way of illustrations and not limitation.

1. A method of configuring communications between a computing device and one or more surface interface electronic (SIE) units, the method comprising:
coupling the one or more SIE units to a communication link;
receiving at the computing device an indication that the one or more SIE units are coupled to the communication link;
selecting one or more of the one or more SIE units for connection; and
transmitting an internet protocol address to the selected SIE units.

2. The method of claim 1, further comprising:
after transmitting, assigning the selected SIE units a unique identifier.

3. The method of claim 1, wherein the indication includes an initial identifier.

4. The method of claim 1, wherein the one or more SIE unit being transmitting the indication when powered on.

5. The method of claim 1, wherein the communication link is an Ethernet.

6. The method of claim 1, wherein at least one of the one or more SIEs is coupled to a multi-component device.

7. A method of configuring the operation of a multi-component device having a plurality of devices, the method comprising
assembling the multi-component device that includes the plurality of devices;
coupling each device to a control line;
receiving at a computing device over the control line a hardware address for each of the plurality of devices;
forming an ordered list of the plurality of devices;
performing a test of the multi-component device; and
changing an order of the of the ordered list based on observations of the test.

8. The method of claim 7, further comprising:
assigning each device a unique identifier.

9. The method of claim 7, wherein the multi-component device is a completion string.

10. The method of claim 9, wherein the devices are serially connected active flow control devices.

11. The method of claim 10, wherein the active flow control devices are valves.

12. The method of claim 7, wherein the control line is a tubing encapsulated connector (TEC).

13. The method of claim 12, further comprising:
coupling the TEC to a surface interface electronic unit.

14. The method of claim 13, further comprising:
coupling surface interface electronic.

15. The method of claim 14, wherein the surface interface electronics are coupled to the computing device by an Ethernet connection.

16. The method of claim 7, further comprising:
disposing the multi-component device in a wellbore.
